(19) United States
(12) Patent Application Publication
(10) Pub. No.: US 2005/0088283 A1
(43) Pub. Date: Apr. 28, 2005

(54) System and method for communicating between a subset of nodes

(76) Inventors: Housh Khoshbin, Hawthorn Woods, IL (US); Kenneth J. Pavloski, Palos Heights, IL (US)

Correspondence Address: James P. Muraff, Esq.;Wallenstein Wagner & Rockey, Ltd., 53rd Floor, 311 South Wacker Drive, Chicago, IL, 60606-6630, US

(21) Appl. No.: 10/869,029

(22) Filed: Jun. 16, 2004

Related U.S. Application Data
(63) Continuation-in-part of application No. 10/661,090, filed on Sep. 12, 2003.
Application No. 10/661,090 is a continuation-in-part of application No. 09/638,825, filed on Aug. 14, 2000.

(51) Int. Cl. H04L 12/28

(52) U.S. Cl. 340/7.48

(57) ABSTRACT

The invention provides a system and method for communicating with a subset of nodes. A node filter is generated representing a set of transmission preferences of at least one node in a set of nodes. The node filter for each node is stored either at the node, or at a central server located remotely from the node. A communication abstract is generated representing the target audience, a subset of nodes, for a communication. The communication abstract and communication are transmitted to the nodes, and the communication abstract is compared to each node filter. Based on the comparison, a determination is made whether to display the communication at the node.

### CROSS-REFERENCE TO RELATED APPLICATIONS

This application is a Continuation-in-Part of U.S. Utility patent application Ser. No. 10/661,090, entitled “Method and Apparatus for Displaying Advertising Indicia on a Wireless Device,” filed Aug. 14, 2000, which is a Continuation-in-Part of U.S. Utility patent application Ser. No. 09/638,825, entitled “Method and Apparatus for Displaying Advertising Indicia On A Wireless Device,” filed Aug. 14, 2000. These applications are incorporated herein by reference.

### TECHNICAL FIELD

The present invention is related to a system and method for communicating between a subset of nodes. More particularly, the present invention relates to a system and method for transmitting or display a communication to or at a node, respectively, based on a comparison between an abstract of the communication and a node filter representing a set of transmission preferences of the node.

### BACKGROUND OF THE INVENTION

Advertisers commonly use mass marketing venues to reach a small target demographic segment of an overall larger group. For example, a diaper manufacturer desires to advertise its product to parents with small children. Since parents with small children watch television, the manufacturer chooses to advertise products on television. However, since many people watch television—not just parents with small children—the manufacturer pays the cost of advertising to the overall group in order to reach the small target demographic group.

Traditional methods of advertising, whether via television, newspaper, radio, or email, thus necessarily require advertising the product to unwanted targets, consumers who are extremely unlikely to be interested in the product. For manufacturers, this cost can be enormous. For example, a television network may charge $500,000 for a broadcast television commercial viewed by 5,000,000 consumers. If 50,000 units are sold as a result of the advertisement, the cost of the exposure to each potential consumer is only $0.10, but the actual advertising cost of each sale is $10. Therefore, the advertising cost per sale is not related to the number of potential targets reached, but rather is related to the number of positive responses from among that group of targets.

It is more efficient, and less expensive, to devise an advertising method by which only those consumers likely to purchase a product are included in the target audience. In terms of the previous example, if an advertisement is transmitted to a targeted audience with a 50% likelihood of purchasing the advertised product, the cost per exposure remains at $0.10, but the advertising cost per sale is reduced from $10 to $0.20.

Targeted advertising is beneficial to the manufacturer, because it reduces the advertising cost associated with each sale. Moreover, broadcasters and consumers also benefit from the method. Broadcasters enjoy a higher rate of use from their viewers, listeners, or users, depending on the broadcast technology. Consumers also benefit by receiving advertisements tailored to their demographic segment, thereby reducing the consumer cost associated with locating a particular product in the marketplace and dispensing with the annoyance of receiving irrelevant advertisement.

Various forms of targeted advertising are in use in the advertising industry today. For example, U.S. Pat. No. 6,708,335 to Ozer et al. discloses a system and method for tracking viewing behavior of advertisements on a home entertainment system. A processing device associated with the home entertainment system determines that an advertisement is being displayed, generates viewing information, and periodically transmits the information to advertisers.

Similarly, U.S. Pat. No. 6,708,176 to Strunk et al. discloses a system and method for interactive advertising. An interactive advertising system presents a multimedia presentation, which may include links to web-based content, to a user. The system may be configured to retrieve and respond to user information collected from the user while the user interacts with the system.

Previously proposed and employed targeted advertising systems, however, can suffer from the substantial delay required to determine the target audience for a communication, since they require that the target audience is known prior to the transmission of the advertisement. Further, previous systems typically do not provide a system for fast and efficient identification of the target audience. Thus, a need has arisen for a system and method for communicating with a target audience which quickly and efficiently identifies the target audience, and is capable of transmitting advertisements to the target audience prior to the identification of that audience.

The present invention is provided to solve these and other problems.

### SUMMARY OF INVENTION

The present invention provides a system and method for communicating between a subset of nodes. A node filter is generated based on a set of transmission preferences corresponding to at least one node of a set of nodes. Since the number of possible transmission preferences is very high, the number of possible unique node filters is also very high. Further, since the set of transmission preferences corresponds to a single node or subset of nodes, the node filter representing that set of transmission preferences thus represents only a subset of the overall set of nodes.

A communication abstract is generated representing a communication. The communication abstract is a representation of the target audience for the communication, i.e. the subset of nodes for which the communication is intended. In the preferred embodiment, the communication abstract and communication are transmitted to all nodes in the set of nodes. For each node, a comparison is made between the communication abstract and the node filter for that node. The comparison is made to determine whether the instant node is included in the target node audience for the communication. The comparison identifies the target node audience because the node filter represents the transmission preferences of the node, and the communication abstract represents the transmission preferences of the target audience. Based upon the comparison between the communication abstract and the node filter, a determination is made whether to display or not display the communication.

In another embodiment, only the communication abstract is transmitted to all nodes in the set of nodes. At each node, a comparison is made between the communication abstract and the node filter for that node. Based upon that comparison, transmission of the communication to that node may be requested, upon which the communication is then sent only to the subset of nodes which resulted in a positive comparison.

In another embodiment, a central server, located remotely from the nodes, stores the node filters for at least a subset of all nodes in the set of nodes. The central server compares the communication abstract with each of the stored node filters, and, based on that comparison, transmits the communication to at least one of the nodes. The node filter, and the communication abstract, may be machine-readable strings of hexadecimal values.

In another embodiment, a display unit is located at each node. Based upon a comparison of the node filter and the communication abstract, the display unit displays the communication. The invention contemplates that the node filter and communication abstract will be generated, stored, and compared by at least one processing unit executing a software application programmed to accomplish the objectives of the system.

Other features and advantages of the invention will be apparent from the following specification taken in conjunction with the following drawings.

### BRIEF DESCRIPTION OF THE DRAWINGS

FIG. 1 is a schematic overview illustrating the system and method for communicating between a subset of nodes, showing the communication between the central server and the set of nodes.

FIG. 2 is an illustration of the portion of the present invention for generating a set of transmission preferences, showing a computer-based form for selecting from among demographic data.

FIG. 3 is a table illustrating the data format of the node filter and communication abstract, showing the elements of the machine-readable codes for the two values.

FIG. 4 is an illustration of a transmission in accordance with the present invention, showing a machine-readable communication abstract transmitted in combination with a communication.

FIG. 5 is an illustration of one embodiment of a node in accordance with the present invention, showing the node and attached display unit.

FIG. 6 is a block diagram illustrating the operation of one embodiment of a node in accordance with the present invention, showing the communication of the elements of the node.

### DETAILED DESCRIPTION

While this invention is susceptible to embodiment in many different forms, there are shown in the drawings and herein described in detail preferred embodiments with the understanding that the present disclosure is considered to provide an example of the principles of the invention, and is not intended to limit the broad aspect of the invention to the embodiments illustrated.

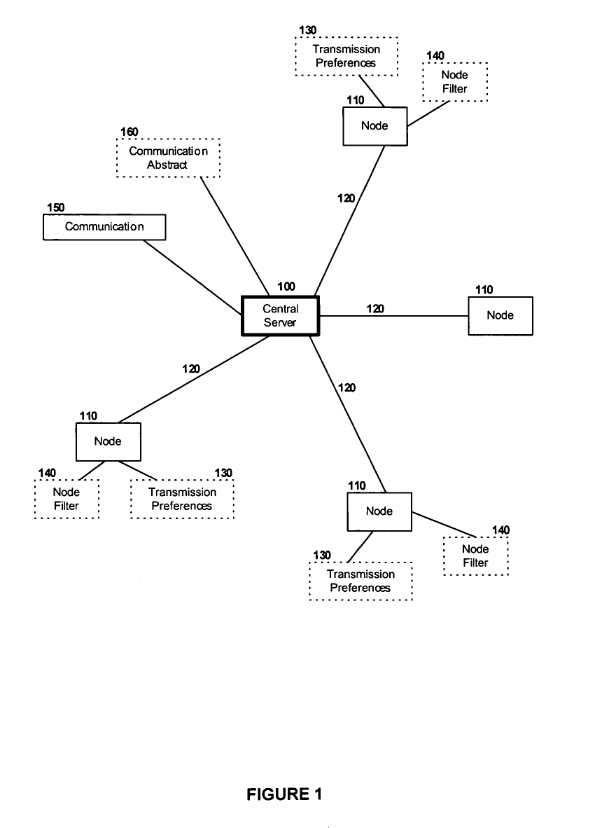

Referring in detail to the drawings and initially to FIG. 1, there is shown a system and method for communicating between a subset of nodes 110. For each node, there is a set of transmission preferences 130. The set of transmission preferences 130 identifies the node 110, and describes the types of communications 150 which are preferred to be received by the node 110. The transmission preferences 130 may be demographic data. For example, the preferences 130 may identify the location of the node 110, or the age of the user of the node 110.

The transmission preferences 130 are to assist in identifying the nodes 110 which should be in the target audience for a communication 150. Demographic information such as age, sex, marital status, children, income, occupation, and personal interests can comprise the set of transmission preferences 130, and identify the user or users of each node 110. For example, if an advertiser wishes to transmit a communication 150 to an audience comprising only users older than fifty, the set of transmission preferences 130 is used to identify the nodes 110 with users within the target audience.

The set of transmission preferences 130 is represented by a node filter 140. In the preferred embodiment, the set of transmission preferences 130 is transmitted from each node 110 to the central server 100, located remotely from the node. The central server 100 generates a node filter 140 representing the set of transmission preferences 130, and transmits the node filter 140 back to the node 110, where it is stored. In another embodiment, the node filter 140 is generated at the node 110, and is stored at the node 110, and is not transmitted to the central server 100. In another embodiment, the node filter 140 is generated by the central server 100, but is stored at the central server 100 instead of being transmitted to the node 110.

The various locations for generating and storing the node filter 140 are optional, depending on the type of communications system embodying the present invention. For example, in a communication system wherein the nodes 110 and server 100 are in regular or constant communication, it may be preferable to generate and store the node filter 140 at the server 100. In a communication system where the server 100 and nodes 110 are not in regular communication, or in a system in which the server 100 is not equipped to process large volumes of transmission preferences 130, it may be preferable to generate and store the node filter 140 at the nodes 110. However, in accordance with the principles of the present invention, the node filter 140 may be generated at either the node 110 or the server 100, and may be stored at either the node 110 or the server 100.

The server 100 generates or receives a communication 150. The communication 150 may be any type of information which is capable of being transmitted to a node 110. For example, the communication 150 may be an advertisement, or a broadcast announcement, or news article. In the preferred embodiment, the communication 150 is a text string of predetermined length capable of efficient and fast transfer via a wireless communications network.

The communication 150 may be generated at the server 100. For example, an advertiser may generate an advertisement using the server 100, wherein the advertisement comprises the communication 150. Alternatively, the communication 150 may be generated elsewhere, and is received by the server 100. For example, an advertiser may generate an advertisement comprising the communication 150, and then may submit that communication 150 to the server 100 for distribution to at least one node 110. In another embodiment, the server 100 neither generates nor receives the communication 150, but instead is for determining the subset of nodes 110 which are to receive the communication. Either of these alternative embodiments is practicable in accordance with the present invention; however, in the preferred embodiment, the server 100 is a dedicated part of a communications network, and is therefore for receiving the communication 150 which is generated elsewhere.

A communication abstract 160 represents the target audience for the communication 150. In other words, the communication abstract 160 represents the subset of nodes for which the communication 150 is to be transmitted. For example, if the communication is an advertisement for diapers, the communication abstract 160 could represent all the nodes 110 having users who are parents. As another example, if the communication 150 is for a company which operates in Boise, Id., the communication abstract 150 could represent all of the nodes 110 located in the Boise region.

The communication abstract 160 represents the communication 150 in that it identifies target attributes of the communication 150; for example, parents, or the Boise region. Since these attributes also represent the target audience, the communication abstract 160 represents the set of nodes which are to receive the communication; for example, the set of nodes having users who are parents, or the set of nodes in the Boise region. Thus, the communication abstract 160 both represents the attributes of the communication 150, and identifies the target subset of nodes 110 which are intended for the communication 150.

The communication abstract 160 is compared to each of the node filters 140. Preferably, both the communication abstract 160 and the node filters 140 are machine-readable strings of hexadecimal values, and thus may be easily compared by a processing unit. In the preferred embodiment, the communication 150 and the communication abstract 160 are both transmitted to all of the nodes 110. The node filters 140 are stored at the nodes 110, and thus the comparison between the node filter 140 and the communication abstract 160 is performed at the node 110. If the comparison between the node filter 140 and communication abstract 160 indicates that the communication 150 is intended for the node 110, the communication 150 is then displayed at the node 110. If the comparison indicates that the communication 150 is not intended for the node 110, the communication 150 is not displayed at the node 110.

In another embodiment, the comparison between the node filters 140 and communication abstract 160 is made at the server 100. Based on this comparison, the server 100 identifies the subset of nodes 110 which are in the target node 110 audience, and transmits the communication 150 only to those nodes 110. Because the comparison involves the communication abstract 160 and not the communication 150 itself, the communication 150 therefore need not be transmitted to the server 100 in this embodiment; the server in this embodiment is for identifying the subset of target nodes 110. The comparison between the node filters 140 and the communication abstract 160 indicates the subset of nodes 110 comprising the target audience. Thus, the target audience may include a single node 110, all of the nodes 110, or some of the nodes 110.

The present invention is practicable in a system in which not all of the nodes 110 have a corresponding node filter 140 or set of transmission preferences 130. This possibility may arise if the user of the node 110 has not determined her transmission preferences 130, or if the determination of transmission preferences 130 is not required by the system. In one embodiment of the present invention, the nodes 110 which do not have a corresponding node filter 140 are included in the target audience by default. In another embodiment, the nodes 110 which do not have a corresponding node filter 140 are not included in the target audience.

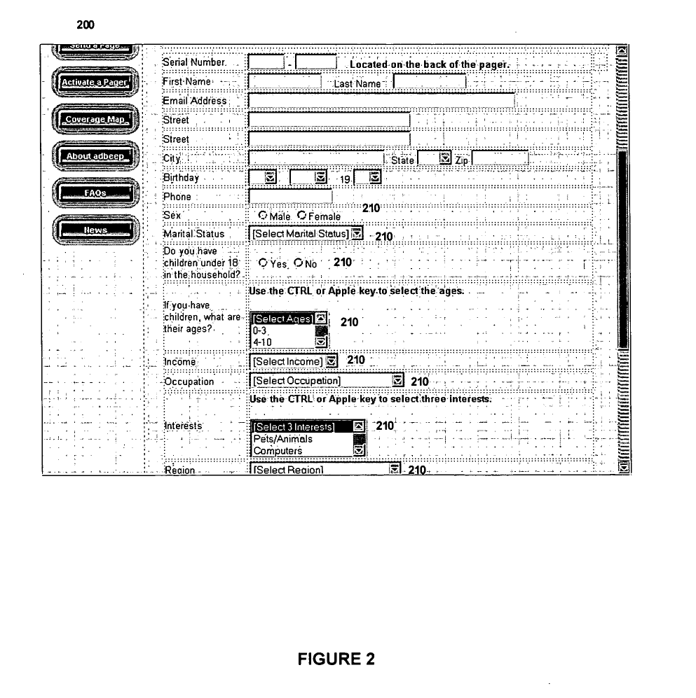

Referring now to FIG. 2, there is shown a computer-based form 200 for the entry of transmission preferences 130. The user of the node 110 selects from among various values 210 identifying the user's demographic data. For example, the user can submit her age, sex, marital status, parental status or number of children, income, occupation, or personal interests. The values 210 comprising the set of transmission preferences 130 may be any type of data which represents the user or the user's interests. As shown in FIG. 2, the user may select these values 210 herself. Alternatively, the values 210 may be submitted by another entity based on the user's input; for example, through a survey method.

In the preferred embodiment, the user provides the values 210 which comprise the set of transmission preferences 130. However, the values 210 may have a default value associated with them; for example, the default marital status may be “single” unless otherwise specified by the user. In the preferred embodiment, the user is not required to provide the values 210 which comprise the set of transmission preferences 130. However, the user may be required to provide the values 210; for example, the user may be required to provide the values 210 before the node 110 is made operational. Additionally, some values 210 may have a default value while others do not, and the user may be required to provide some values 210 but may not be required to provide others; all such combinations are practicable in accordance with the principles of the present invention.

The values 210 comprising the set of transmission preferences 130 are, preferably, capable of change by the user of the node 110. For example, if the user's marital status changes from “single” to “married”, the user may optionally change this value 210, and thus update her set of transmission preferences 130, her node filter 140, and thereby the types of communications 150 received by the node 110. Some types of values 210 may also be automatically updated. For example, if the user provides that her age is “35”, this value 210 may be incremented to “36” one year later without the need for user involvement. Preferably, a change made to the values 210 comprising the set of transmission preferences 130 results in a change to the node filter 140, and thus a change in the communications 150 received by the node 110.

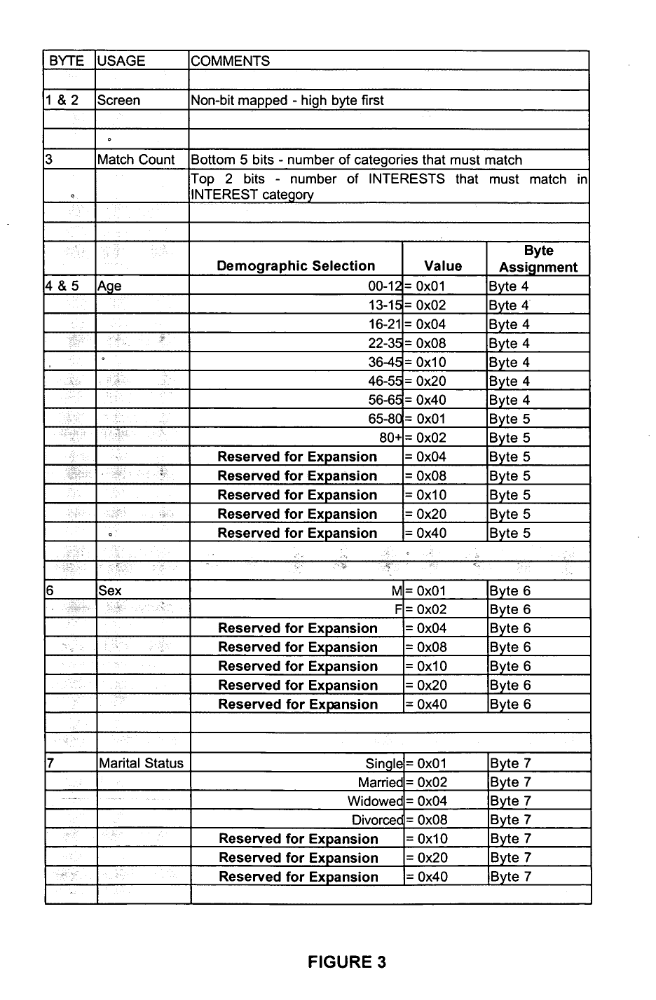

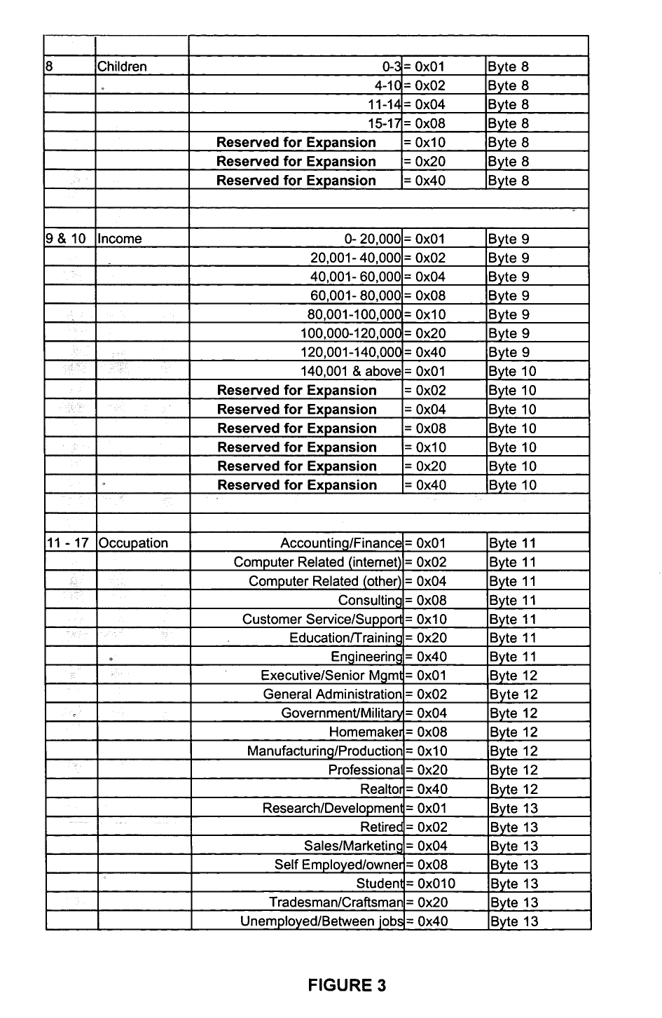

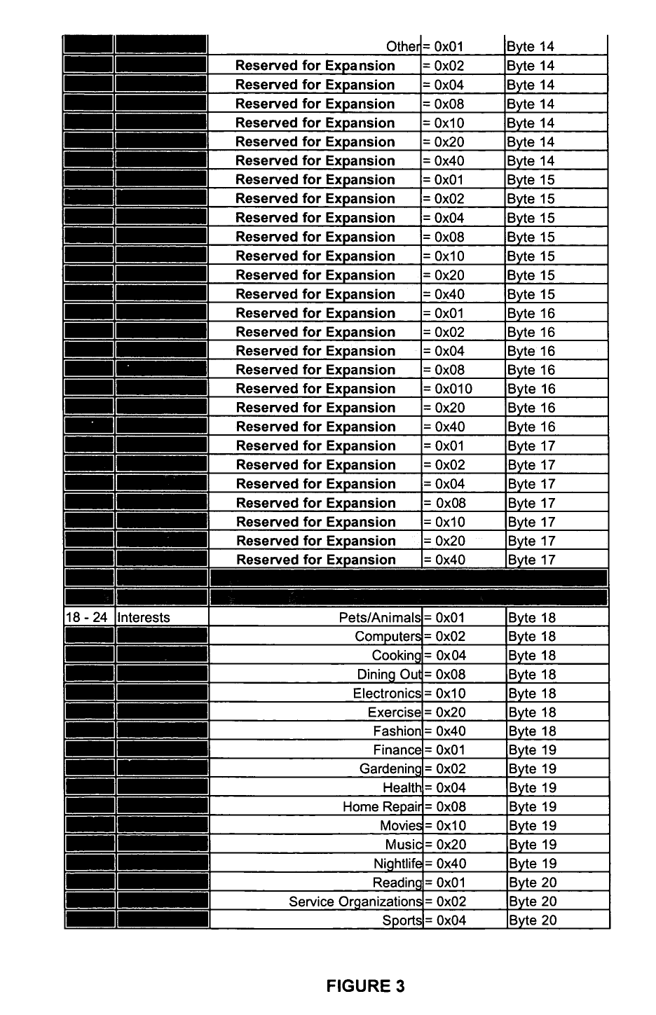

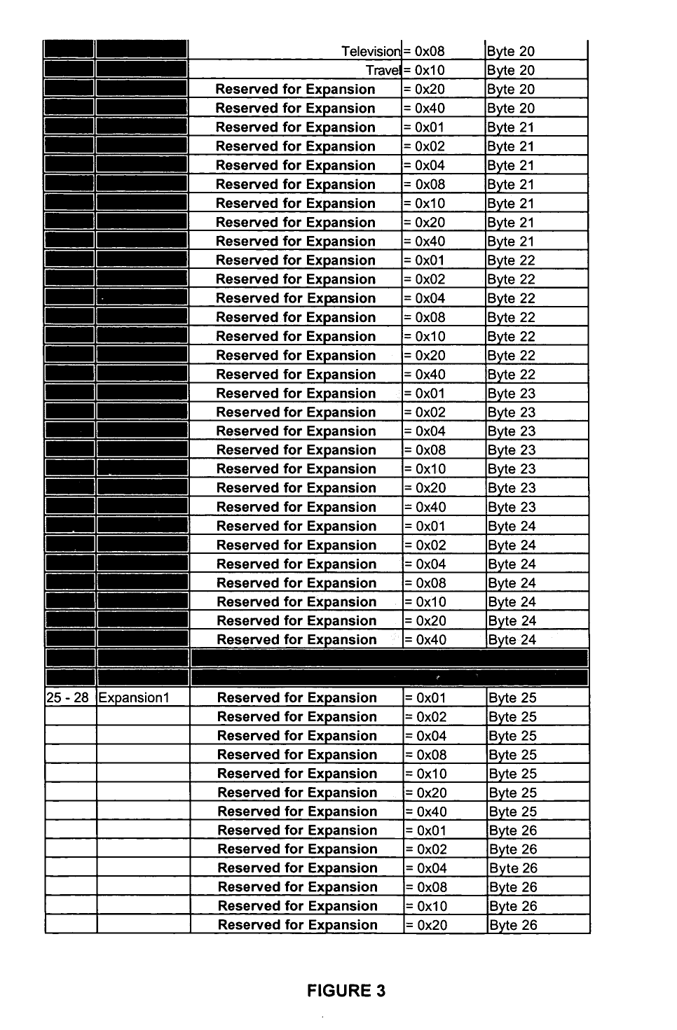

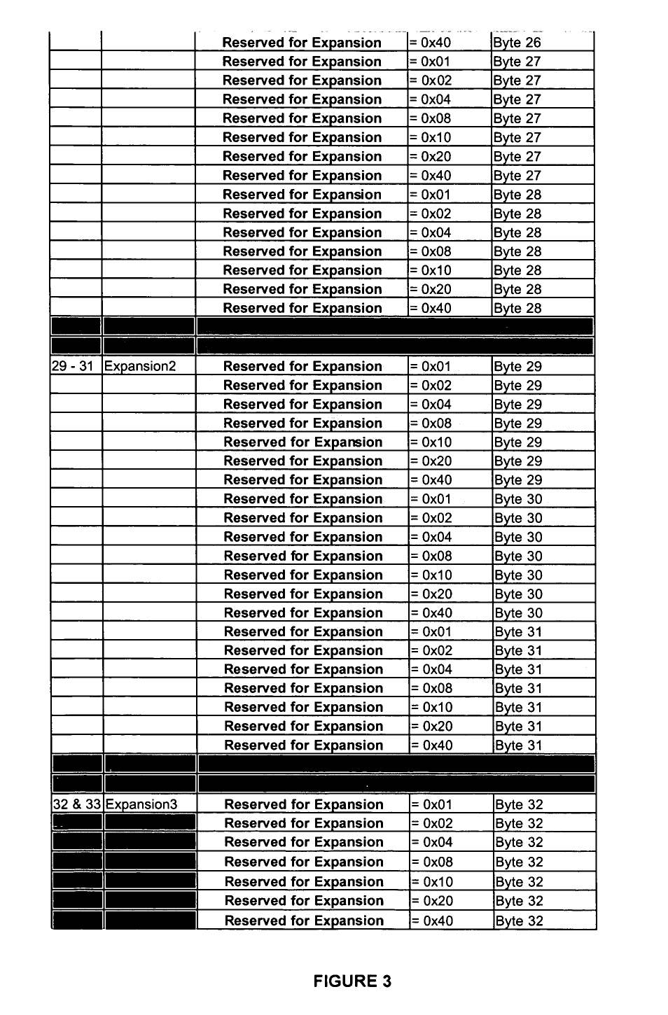

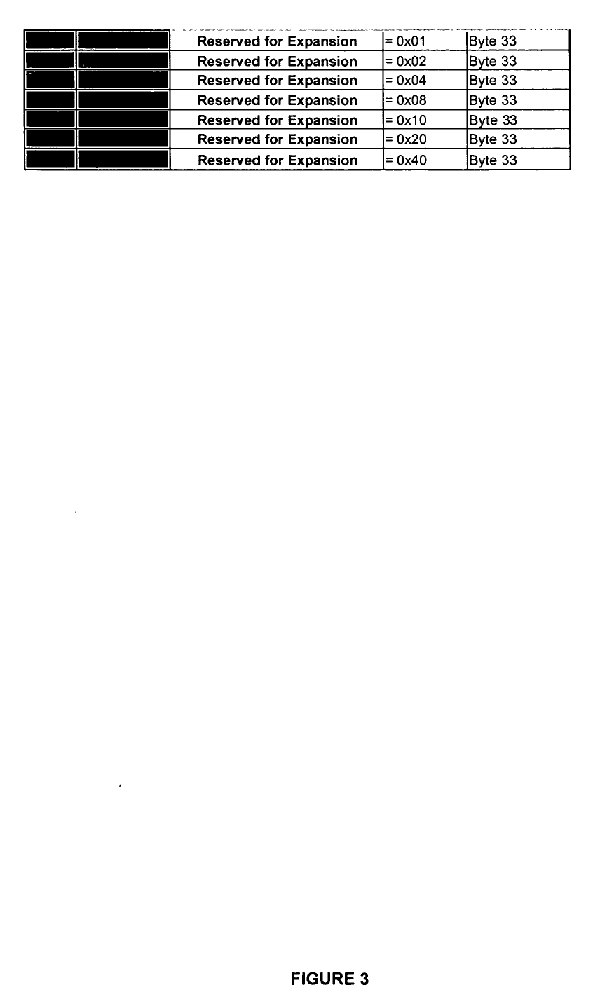

Referring now to FIG. 3, there is shown a table illustrating the data format for the node filter 140 and communication abstract 160, which are preferably stored as a string of machine-readable hexadecimal values. As shown in the table, each element 300 of the string represents either the transmission preferences 130 of the node 110, or the target audience for the communication 150, depending respectively on whether the string is a node filter 140 or a communication abstract 160. In a hexadecimal string, each value position in the string is a bit, or eight bits of binary data. For example, in a string representing the node filter 140 or communication abstract 160, as illustrated in FIG. 3, the fourth position could represent the age of the user of the node 110 or the age of the target audience, depending respectively on whether the string is a node filter 140 of a communication abstract 160.

As shown in FIG. 3, each position in the string represents a value of the node filter 140 or communication abstract 160. In the illustrated embodiment, the third byte 300 represents the sex of the user, the fourth byte 300 represents marital status, and so on. Within each byte 300, each bit 320 can be used to represent a specific value within the general category. For example, in the third byte 300 in the string, representing the sex of the user, the first bit 310 represents male, and the second bit 310 represents female. In this example, if the user is male, the first and second bits 310 in the third byte 300 will be “10,” and the hexadecimal value of the sixth byte 300 will be “1.” If the user is female, the first and second bits 310 in the third byte 300 will be “01,” and the hexadecimal value of the third byte 300 will be “2.” Thus, each of the hexadecimal values 300 represents one aspect of either the user or the target audience, and each bit 310 within that byte 300 can further refine the user or target audience.

The comparison between node filters 140 and communication abstract 160 is therefore, in the preferred embodiment, a comparison of two strings of hexadecimal values. For example, the communication abstract may thus specify a target audience of “all male users between the ages of 35 and 50 interested in gardening.” The hexadecimal values in this communication abstract 160 are compared to the hexadecimal values in the node filters 140. If the hexadecimal values of the node filter 140 fall into the range specified in the communication abstract 160, that node 110 will display the communication 150.

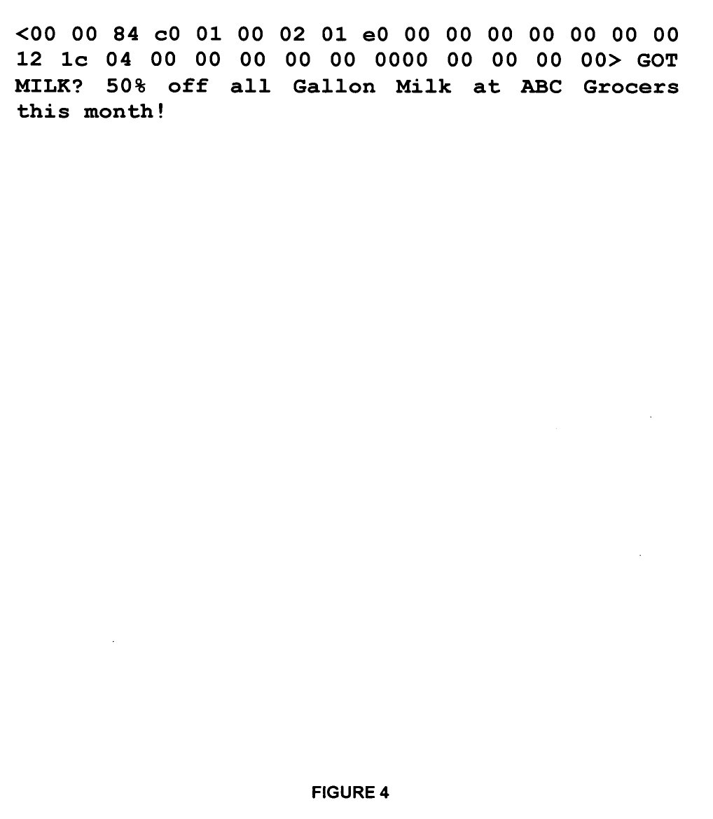

Referring now to FIG. 4, there is shown an exemplary data transmission to a node 110 in accordance with the present invention. The first portion of the transmission is the communication abstract 400, represented in the form of a string of hexadecimal values. The communication abstract represents the target audience for this transmission. The second portion of the transmission is the communication 410. The communication abstract 400 is compared to the node filter 140 of the node 110. If the node filter 140 indicates that the transmission preferences 130 fall within the target audience for the communication 410, the communication 410 is displayed at the node 110.

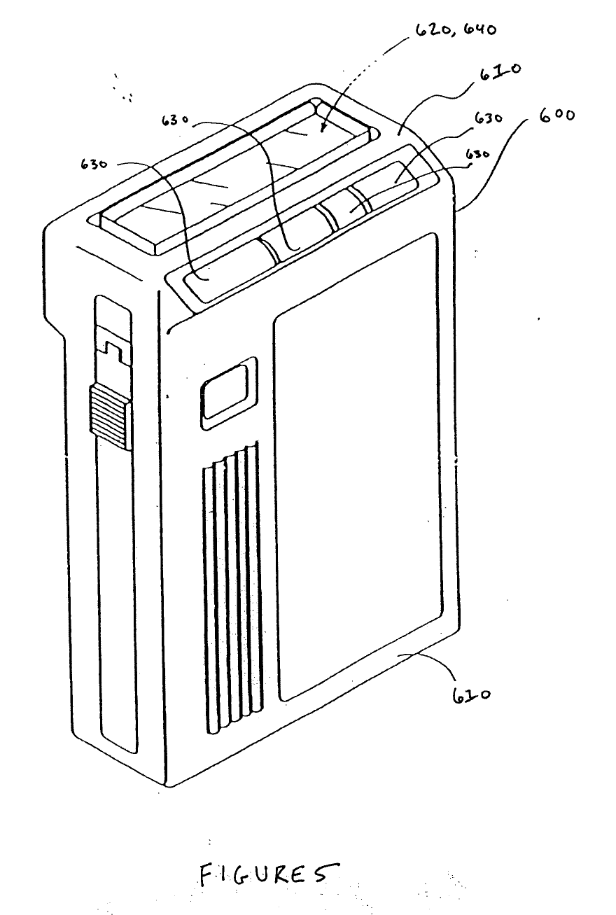

The node 110 is preferably a wireless device comprising a mobile or computing device capable of electronic wireless communication and having a processor and memory such as a pager 600, a personal digital assistant, a handheld computer, or a laptop computer. Referring now to FIG. 5, there is shown one preferred embodiment of a node 110: a wireless pager 600. The pager 600 has an identity in the form of a frequency or small frequency range with which signals are sent to the pager 600, and which the pager 600 will recognize and respond to. The pager 600 is used for notifying a user of a page directed specifically to the pager 600. The page can be a person or a number to reach the person sending the page. The pager 600 has a housing 610 and a display 620 attached to the housing 610. The display 620 may be a liquid crystal display. The pager 600 includes a plurality of multi-function soft keys 630 for allowing the user to control the operation of the pager 600, such as selecting a message to read or a folder to open. The multi-function keys 630 may be soft multi-function keys thereby allowing their functions to be changed or modified allowing different screens to utilize different functions for the same multi-function keys. The display 620 and the plurality of multi-function keys 630 create an interface 640 by which the user operates the pager 600.

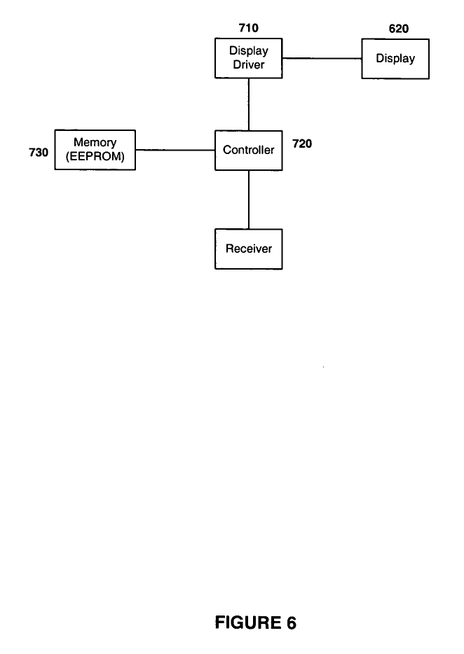

Referring now to FIG. 6, there is shown in further detail the wireless pager 600 node embodiment. A display driver 710 is electrically connected to the display 620 for causing indicia to appear on the display 620. The display driver 710 may be a liquid crystal display driver. A controller or microprocessor 720 is connected to the display driver 710 for sending to the display 620 a signal that has indicia therein. In one form of the present invention, the controller 720 is an MCU Hitachi 3827 microprocessor. The controller 720 and the display driver 710 work together to cause indicia to appear on the display 620. The pager 600 also has an electrically erasable programmable read only memory (EEPROM) 730. The EEPROM 730 can be programmed with advertising and other communication data, as discussed above. The pager 600 has an audible and/or vibrating alarm for notifying the user when a page is taking place or has taken place. The pager 600 further comprises a power source for powering the controller 720, the display 620, and other components. A receiver is electrically connected to the controller, for receiving a page signal directed specifically at the identity of the pager 600. The receiver will communicate the page signal to the controller 720 and alert the user to the receipt of the page signal.

The controller 720 is preferably capable of executing software, particularly software stored in memory 730. The controller 720 can be any custom-made or commercially-available processor, a central processing unit, a semiconductor-based microprocessor in the form of a microchip or chip set, or an auxiliary processor operating in serial, parallel, or otherwise distributed conjunction with other processors. In addition to the preferred MCU Hitachi 3827 microprocessor, examples of processors capable of performing as the controller 720 include the 80×8 or Pentium series microprocessors from Intel Corporation, a PowerPC microprocessor from International Business Machines, a Sparc microprocessor from Sun Microsystems, or an 8-series microprocessor from Motorola Corporation.

Memory 730 can include any one or a combination of volatile memory elements; for example, random access memory (RAM, such as DRAM, SRAM, and SDRAM) and nonvolatile memory elements (ROM, such as a hard drive, tape, CDROM, and EEPROM). Moreover, memory 730 may incorporate magnetic, optical, and other types of storage media. The memory 730 can have a distributed architecture whereby various components are situated remotely from one another, but can be accessed by the controller 720.

It will be understood that the invention may be embodied in other specific forms without departing from the spirit or central characteristics thereof. The present embodiments, therefore, are to be considered in all respects illustrative and not restrictive, and the invention is not to be limited to the details given herein.

1. A method of communicating between a subset of nodes, comprising the steps of:
providing for generating a node filter representing a set of transmission preferences of at least one node of a set of nodes;
providing for generating a communication abstract representing a communication; and,
providing for selecting at least one node from the set of nodes based on a comparison of the node filter and the communication abstract.

2. The method of claim 1, further comprising the step of:
providing for receiving a set of transmission preferences from at least one node.

3. The method of claim 1, further comprising the step of:
providing for comparing the node filter and the communication abstract.

4. The method of claim 1, further comprising the step of:
providing for transmitting the communication to the at least one selected node.

5. The method of claim 1, further comprising the step of:
providing for receiving a communication.

6. The method of claim 1, further comprising the step of:
providing for retrievably storing the node filter.

7. The method of claim 1, further comprising the step of:
providing for transmitting the node filter to at least one node.

8. The method of claim 1, further comprising the step of:
providing for transmitting the communication to all nodes in the set of nodes.

9. The method of claim 1, wherein the node filter is a machine-readable string of hexadecimal values.

10. The method of claim 1, wherein the step of selecting the at least one node is performed by a server located remotely from the at least one selected node.

11. The method of claim 1, further comprising the step of:
providing for comparing the node filter and the communication abstract.

12. The method of claim 11, wherein the step of comparing the node filter and the communication abstract is performed by a server located remotely from the at least one node.

13. The method of claim 11, wherein the step of comparing the node filter and the communication abstract is performed at the location of the node.

14. The method of claim 1, wherein the communication abstract is a machine-readable string of hexadecimal values.

15. A system for communicating between a subset of nodes, comprising:
a set of nodes wherein at least one node of the set has a set of transmission preferences represented by a node filter;
a communication represented by a communication abstract; and, a server for selecting the at least one node based on a comparison of the node filter and the communication abstract.

16. The system of claim 15, further comprising a communication link whereby the server and the at least one node are in communication.

17. The system of claim 15, wherein the set of transmission preferences are transmitted from the at least one node to the server.

18. The system of claim 15, wherein the server compares the node filter and the communication abstract.

19. The system of claim 15, wherein the server transmits the communication to the at least one node.

20. The system of claim 15, wherein the server retrievably stores the node filter.

21. The system of claim 15, wherein the server generates the node filter.

22. The system of claim 21, wherein the server transmits the node filter to the at least one node.

23. The system of claim 15, wherein the server transmits the communication to all nodes in the set of nodes.

24. The system of claim 15, wherein the node filter is a machine-readable string of hexadecimal values.

25. The system of claim 15, wherein the communication abstract is a machine-readable string of hexadecimal values.

26. The system of claim 15, wherein the server generates the communication abstract.

27. The system of claim 15, wherein the server transmits the communication abstract to the at least one node.

28. A system for communicating between a subset of nodes, comprising:
a processor for executing an application; and,
a memory in communication with the processor,
wherein the application comprises:
a first code segment for generating a node filter representing the transmission preferences of at least one node of a set of nodes;
a second code segment for generating a communication abstract representing a communication; and,
a third code segment for selecting at least one node from the set of nodes based on a comparison of the node filter and the communication abstract.

29. The system of claim 28, wherein the application further comprises:
a fourth code segment for receiving a set of transmission preferences from at least one node.

30. The system of claim 28, wherein the application further comprises:
a fourth code segment for comparing the node filter and the communication abstract.

31. The system of claim 28, wherein the application further comprises:
a fourth code segment for transmitting the communication to the at least one selected node.

32. The system of claim 28, wherein the application further comprises:
a fourth code segment for receiving a communication.

33. The system of claim 28, wherein the application further comprises:
a fourth code segment for retrievably storing the node filter.

34. The system of claim 28, wherein the application further comprises:
a fourth code segment for transmitting the node filter to at least one node.

35. The system of claim 28, wherein the application further comprises:
a fourth code segment for transmitting the communication to all nodes in the set of nodes.

36. The system of claim 28, wherein the node filter is a machine-readable string of hexadecimal values.

37. The system of claim 28, wherein the application is executed remotely from the at least one selected node.

38. The system of claim 28, wherein the application further comprises:
a fourth code segment for comparing the node filter and the communication abstract.

39. The system of claim 28, wherein the application is executed remotely from the at least one node.

40. The system of claim 28, wherein the application is located at the at least one node.

41. The system of claim 28, wherein the communication abstract is a machine-readable string of hexadecimal values.

42. The system of claim 28, wherein the application further comprises:
a fourth code segment for generating the communication abstract.

43. The system of claim 42, wherein the application further comprises:
a fifth code segment for transmitting the communication abstract to at least one node.

44. A method for communicating between a subset of nodes, comprising the steps of:
receiving a set of transmission preferences from at least one node of a set of nodes;
generating a node filter representing the set of transmission preferences;
transmitting the node filter to the at least one node;
generating a communication abstract representing a communication;
transmitting the communication and the communication abstract to all nodes in the set of nodes; and,
choosing whether to display the communication at the at least one node based on a comparison of the node filter and the communication abstract.

45. A system for communicating between a subset of wireless communication devices, comprising:
a set of wireless communication devices wherein at least one of the wireless communication devices has a set of transmission preferences represented by a device filter;
an advertisement represented by an advertisement abstract; and,
a computer for selecting the at least one wireless communication device based on a comparison of the device filter and the advertisement abstract.
